(19) United States
(12) Patent Application Publication
(10) Pub. No.: US 2016/0060568 A1
(43) Pub. Date: Mar. 3, 2016

(54) PROCESS FOR IMPROVING AQUEOUS ENZYMATIC DEGUMMING OF VEGETABLE OILS

(71) Applicant: CLARIANT PRODUKTE (DEUTSCHLAND) GMBH, Frankfurt am Main (DE)

(72) Inventors: Ulrich SOHLING, Freising (DE); KIRSTIN SUCK, Muenchen (DE); Friedrich RUF, Tiefenbach-Ast (DE); Paul BUBENHEIM, Hamburg (DE)

(21) Appl. No.: 14/784,237

(22) PCT Filed: Apr. 15, 2014
(86) PCT No.: PCT/EP2014/001014

§ 371 Date: Oct. 13, 2015

(30) Foreign Application Priority Data
Apr. 16, 2013 (EP) EP13163922.1

(51) Int. Cl. C11B 3/00

(52) U.S. Cl. CPC C11B 3/003

(57) ABSTRACT

A method for degumming vegetable oils or reducing the oil content in vegetable oil gum using at least one glycoside-breaking enzyme, wherein the at least one glycoside-breaking enzyme does not exhibit phospholipase or acyltransferase activity, and the composition does not contain phospholipase or acyltransferase.

The invention concerns a process for the enzymatic degumming of triglycerides, specifically of crude vegetable oils, wherein the phosphatides remain unchanged. The subject matter of this invention also comprises a process for reducing the oil content in vegetable oil gum or recovering lecithin from vegetable oils, particularly rapeseed and soy oil.

Crude vegetable oils contain phosphatides, protein- and carbohydrate-containing substances, vegetable gums, and colloidal compounds which sharply reduce the storage life of the oil. These substances must therefore be removed.

In refining of vegetable oils, undesirable associated substances are removed. A distinction is made between chemical and physical refining. Chemical refining consists of the processes 1. degumming, 2. neutralization, 3. bleaching, and 4. deodorizing. In degumming, phospholipids (“gums”) and metal ions are removed from the oil. Neutralization serves to extract fatty acids. In bleaching, colorants, additional metal ions, and residual gums are removed. Deodorizing is steam distillation in which additional compounds that impair the odor and taste of the oil are removed. In physical refining, deacidification is carried out together with deodorizing at the end of the refining process.

Degumming of the oil can be carried out by extraction of the phospholipids with water or an aqueous solution, or an acid that complexes Ca²⁺ and Mg²⁺ ions, such as citric acid or phosphoric acid. In this case, an aqueous process known as pre-gumming is often carried out first to remove the water-soluble phospholipids. These are referred to as hydratable phospholipids.

The subject of the hydratable and non-hydratable phospholipids is described for example in Nielsen, K., Composition of difficulty extractable soy bean phosphatides, J. Am. Oil. Chem. Soc. 1960. 37. 217-219 and A. J. Dijkstra, Enzymatic degumming, Eur. J. Lipid Sci. Technol., 2010, 112, 1178-1189. In particular, phosphatidyl choline and phosphatidyl inositol are discussed. In the prior art, treatment with dilute aqueous calcium- and magnesium-complexing acids, such as citric acid or phosphoric acid, has caused non-hydratable phospholipids to be converted to hydratable phospholipids. A further variant is referred to as “caustic refining.” This process is used in order to remove, to the extent possible, all phospholipids, together with free fatty acids, from the oil. This process is described, for example, in WO 08/094847.

A further drawback of conventional oil degumming processes is that both aqueous pre-degumming and treatment with aqueous acids lead to oil losses, which are caused by the fact that the phospholipids transferred into the water are emulsifiers that emulsify a small portion of the vegetable oil in the aqueous phase, causing vegetable oil to be lost.

The process referred to as enzymatic degumming avoids several drawbacks of existing processes or improves the extraction process. Enzymatic degumming is described in prior art with the use of phospholipases, particularly phospholipase A1 and A2, B, or phospholipase C or a combination of phospholipases.

A further variant of enzymatic oil degumming was the enzymatic treatment of the separated gum phase, after which the oil was degummed according to conventional processes, such as with water and/or citric acid. By this method, additional valuable crude materials could be obtained, such as lecithin.

In recovery of lecithin for use foods or in animal feedstuffs, the lecithin is recovered from an aqueous solution that is obtained by aqueous pre-degumming of vegetable oil. In this process, the water is removed using a thin film evaporator.

In prior art, de-oiling of the crude lecithin is essentially achieved by means of acetone extraction, as described for example in WO 94/01004. De-oiling of the crude lecithin is required for most applications when the lecithin is to be used as an emulsifier, as the oil present reduces emulsifiability, and also decrease the active content of the lecithin.

In use as a feedstuff component as well, it is advantageous in some cases to de-oil the crude lecithin.

The present invention takes as its object to improve the degumming of triglycerides in such a manner that while the phospholipids remain unaltered in their chemical structure and consequently in their emulsion behavior as well, less oil remains in the separated gum. One purpose of the invention is therefore to increase oil yield.

A further object of the invention is to provide a process for the recovery of lecithin from triglycerides, particularly crude soy, sunflower, or rapeseed oil, with a high yield and without chemical alteration of the lecithin, wherein the content of oil in the recovered lecithin is as low as possible, in other words, a process for de-oiling of the lecithin or reduction of the oil content in the vegetable oil gum.

The object is achieved by means of a process for the enzymatic degumming of triglycerides or reduction of the oil content of the vegetable oil gum that accumulates during oil degumming, said process comprising the following steps:

First, the triglyceride or vegetable oil gum that accumulates in oil degumming is brought into contact in Step a) with a composition that contains at least one glycoside-cleaving enzyme, with the at least one glycoside-cleaving enzyme not exhibiting phospholipase or acyltransferase activity and the composition not containing phospholipase or acyltransferase.

After this, when triglycerides are used as the starting material, the gums in Step b1) are separated from the triglycerides. Preferably, the triglycerides used should be crude vegetable oil.

Alternatively, instead of triglycerides, vegetable oil gum can be used that accumulates during degumming of vegetable oils, whether it arises in degumming according to a conventional process or the process according to the invention. The vegetable oil gum is brought into contact with the glycoside-cleaving enzyme according to Step a), and then divided into an aqueous, lecithin-containing phase and an oil-containing phase according to Step b2), which is carried out analogously to Step b1). The gum phase or the vegetable oil gum is used in particular in the recovery of lecithin.

“Enzyme activity” is defined within the scope of the present invention as a chemical reaction catalyzed by one or more catalytic proteins (enzymes). In this reaction, an enzyme substrate is converted to one or more products. Certain enzymes or enzyme compositions possess one or even several enzymatic activities. Even a pure enzyme, for example, can catalyze more than one reaction (conversion of a substrate to product(s)), and therefore has more than one enzymatic activity. These activities are divided into what is referred to as “primary activity” and “secondary activity.” Enzymatic activity is associated with reaction rate. It indicates how much active enzyme is contained in an enzyme composition. The unit of enzymatic activity is the enzyme unit (U), with 1 U being defined as the amount of an enzyme that converts one micromole of substrate per minute under given conditions: 1 U=1 μmol/min.

Phospholipid-cleaving secondary activity is defined in the present invention such that the content of free fatty acids during a reaction time of 4 h increases by not more than 10% on a relative basis, preferably by not more than 8% on a relative basis, and particularly preferably by not more than 5%. These values refer to the relative increase in fatty acid concentration, which is defined as the percentage of free fatty acids (FFA), expressed as oleic acid, with respect to the total fatty acids. The determination of free fatty acids (FFA) is described in the section “Methods.”

Phospholipid-cleaving secondary activity below 5% is not defined within the scope of the present invention as secondary activity, but is within the range of the usual measurement fluctuation.

Phospholipid-cleaving primary activity is defined in the present invention such that the content of free fatty acids during a reaction time of 4 h increases by more than 10° %, preferably by more than 12° %, and particularly preferably by more than 15° %. These values refer to the relative increase in fatty acid concentration, which is defined as the percentage of free fatty acids (FFA), expressed as oleic acid, with respect to the total fatty acids.

Secondary phosphatase activity (hydrolysis of a phosphate ester bond) is defined in the present invention such that the content of free fatty acids during a reaction time of 4 h increases by not more than 10% on a relative basis, preferably by not more than 8% on a relative basis, and particularly preferably by not more than 5%. These values refer to the relative increase in fatty acid concentration, which is defined as the proportion of free fatty acids (FFA), expressed as oleic acid, with respect to the total fatty acids. The determination of free fatty acids (FFA) is described in the section “Methods.”

Secondary phosphatase activity (hydrolysis of a phosphate ester bond) of below 5% is not defined within the scope of the present invention as secondary activity, but is within the range of the usual measurement fluctuation.

Primary phosphatase activity (hydrolysis of a phosphate ester bond) is defined in the present invention such that the content of free fatty acids during a reaction time of 4 h increases by more than 10° %, preferably by more than 12° %, and most particularly preferably by more than 15° %. These values refer to the relative increase in fatty acid concentration, which is defined as the percentage of free fatty acids (FFA), expressed as oleic acid, with respect to the total fatty acids.

The term “triglycerides” is understood to refer to triesters of glycerol with fatty acids, which constitute the main component of natural fats and oils, whether of vegetable or animal origin. Triglycerides include vegetable or animal fats and oils, as well as mixtures thereof, both mixtures of such fats and oils and mixtures with synthetic or modified fats and oils.

The term “vegetable oil” is understood to refer to any oil of vegetable origin. Preferred oils within the meaning of the present invention are soy oil, rapeseed oil, sunflower oil, olive oil, palm oil, jatropha oil, camelina oil, or cottonseed oil. In addition, the vegetable oil within the meaning of the present invention also includes mixtures of different vegetable oils with one another, as well as mixtures of vegetable oil with animal and/or synthetic or modified fats and oils. Within the scope of the present invention, the term “vegetable oil” includes crude, pre-conditioned, and pre-degummed vegetable oils.

In this case, the term “crude” refers to the fact that the oil has not yet been subjected to any degumming, neutralization, bleaching, and/or deodorizing step. It is also possible within the scope of the present invention that a mixture of several crude oils is used or pretreated, e.g. pre-degummed and/or pre-conditioned oils are treated with the enzymes.

Within the scope of the present invention, the terms “lecithin phase”/“gum phase”/“gums”/“vegetable oil gum” are understood to refer to the entire group of substances which, after treatment with an acid-containing and/or aqueous solution, are deposited from the oil as a heavy phase (Michael Bokisch: Fats and Oils Handbook, AOCS Press, Champaign, Ill., 1998. Pages 428-444). The terms are used within the scope of the present invention as synonyms. The use of this vegetable oil gum as a feed material is particularly significant for the recovery of lecithin, as lecithin is an essential component of vegetable oil gum.

The term “reduction of the oil content of the vegetable oil gum” is understood to refer within the scope of the present invention to separation of the oil from the vegetable oil gum used, which is thus “de-oiled.”

Depending on the respective point of view, the focus is on either the recovery of oil and/or the recovery of the lecithin-containing gum phase.

The term “pre-degumming” or “wet degumming” is understood to refer within the scope of the present invention to treatment of the crude oil with water or an aqueous acid solution in order to remove water-soluble phospholipids from the oil to the greatest extent possible. These two terms are used within the scope of the present invention as synonyms. During pre- or wet degumming, after acid addition, an alkali may also be optionally added in order to neutralize the acid. Separation of the aqueous phase takes place before enzyme addition. After pre-degumming, the phosphorus content in the crude oil of approx. 500-1500 ppm is decreased to less than 200 ppm in the pre-degummed oil, e.g. for soy and rapeseed. By means of pre-degumming, one can recover lecithin, for example, from the resulting gum phase, or reprocess the gum phase as a feedstuff. The drawback of separation of the aqueous phase or decreasing the phosphorus content, however, is a low in oil yield. The phosphatides converted to the aqueous phase have an emulsifying effect and cause a portion of the oil to be emulsified in the aqueous phase and separated together with said phase. After this, the oil can be subjected to further enzymatic processing, with it being necessary to separate the enzymes in a further step.

The term “pre-conditioning” of the oil is understood to refer within the scope of the present invention to the addition of water or an aqueous acid solution to the crude oil. After this, by adding an alkali such as a sodium hydroxide solution, pH is adjusted to a level at which the subsequent enzymatic reaction takes place. Ideally, the optimum pH for the enzyme reaction is established. However, this is followed not by separation of the aqueous phase, but by immediate addition of the enzymes. Therefore, the gums temporarily remain in the oil or the emulsion. Separation of the aqueous phase and thus the enzymes does not take place until the enzymes have acted on the (optionally pre-conditioned) crude oil.

A triglyceride within the meaning of the present invention is preferably a vegetable oil, and particularly preferably a crude vegetable oil, or a mixture of a vegetable and an animal oil.

In particular, the at least one glycoside-cleaving enzyme exhibits substrate-specificity such that it cleaves α(1-4)glycosidic, α(1-2)glycosidic, α(1-6)glycosidic, β(1-2)glycosidic, β(1-3)glycosidic, β(1-4)glycosidic and/or β(1-6)glycosidic bonds. Preferably, α(1-4)glycosidic bonds are cleaved.

In one embodiment, the at least one glycoside-cleaving enzyme is selected from amylases, amyloglucosidases, isoamylases, glucoamylases, glucosidases, galactosidases, glucanases, pullulanases, arabinases, laminazanases, pectolyases, mannanases, dextranases, pectinases, cellulases, cellobiases, and xylanases.

In particular, the amylase is an α-amylase, and preferably an α-amylase that specifically cleaves α(1-4)glycosidic bonds.

It is particularly preferred if the α-amylase is derived from the following species: Bacillus spp., Bacillus subtilis, Bacillus licheniformis, Bacillus megaterium, Bacillus amyloliquefaciens, Bacillus stearothermophilus, Pseudomonas aeruqinosa, Pseudomonas fluorescens, Aspergillus oryzae, or Aspergillus niger, also in particular Bacillus subtilis and Aspergillus oryzae.

In a preferred embodiment, α-amylase alone is used as an enzyme, particularly α-amylase derived from Bacillus subtilis and/or Aspergillus oryzae.

According to a preferred embodiment, the plurality of glycoside-cleaving enzymes used can be in supported form.

The oils preferably used in the present invention are soy oil, rapeseed oil, sunflower oil, olive oil, palm oil, jatropha oil, rice bran oil, peanut oil, camelina oil, or cottonseed oil, particularly soy oil, rapeseed oil or sunflower oil. These oils should preferably be used in crude form (crude oils) in the process according to the invention according to Steps a) and b1).

Alternatively, instead of the vegetable oil itself, a vegetable oil gum can be used in Steps a) and b2) that was obtained by separation from the aforementioned oil. This allows the oil contained in the gum phase to be recovered, and also allows the lecithin contained in the gum to be de-oiled.

One embodiment concerns the use of a glycoside-cleaving enzyme to increase oil yield in carrying out aqueous oil degumming, and also to reduce the oil content of the lecithin phase de-oil the lecithin.

The enzymes used for the process according to the invention are enzymes that do not constitute phospholipid-cleaving enzymes.

A “phospholipid-cleaving enzyme” can be a phospholipase capable of cleaving either a fatty acid residue or a phosphatidyl residue or a head group from a phospholipid. Examples are phospholipase A1, phospholipase A2, phospholipase C, phospholipase B, phospholipase D, or mixtures of phospholipases. Moreover, it can also be an enzyme referred to as an acyltransferase, in which the cleavage of the fatty acid residue is associated with transfer of this residue, followed by esterification with a free sterol in the oil phase. Within the scope of the present invention, a “phospholipid-cleaving” enzyme refers to any enzyme that exhibits phospholipase activity and/or acyltransferase activity as its primary or secondary activity.

In a particularly preferred embodiment, the composition does not contain phospholipid-cleaving enzymes.

Moreover, it is preferred within the scope of the present invention not to use any phosphatases, i.e. enzymes having phosphatase activity as their primary activity, or additional enzymes, particularly glycoside-cleaving enzymes, having phosphatase activity as their primary or secondary activity. The term “phosphatase activity” is understood within the scope of the present invention to mean that the enzyme can cleave phosphoric acid from phosphate esters or polyphosphates.

In a particularly preferred embodiment, the composition does not contain enzymes that exhibit phosphatase activity.

With respect to the glycoside-cleaving enzymes according to the invention, those that can cleave α(1-4)glycosidic, α(1-2)glycosidic, α(1-6)glycosidic, β(1-2)glycosidic, β(1-3)glycosidic, β(1-4)glycosidic and/or β(1-6)glycosidic bonds, e.g. amylases, amyloglucosidases, isoamylases, glucoamylases, glucosidases, galactosidases, glucanases, pullulanases, arabinases, laminaranases, pectolyases, mannanases, dextranases, pectinases, cellulases, cellobiases, and xylanases are preferred. In this case, a combination of two or more of the aforementioned glycoside-cleaving enzymes can also be used.

In this case, the enzymes can also be derived from any desired organism (e.g. isolated from a thermophilic organism) or a synthetic source. It is also possible within the scope of the present invention to use enzymes that are of the same type but are derived from different sources or species. This also includes chimeric fusion proteins produced by recombinant methods from two or more different species having enzymatic activity.

Moreover, amylases, particularly α-amylases, β-amylases, γ-amylases and isoamylases, as well as mannanases, are preferred.

With respect to the amylases and mannanases, those derived from Bacillus, Pseudomonas, or fungal species or from the (mammalian) pancreas are preferred, particularly those derived from Bacillus spp., Bacillus subtilis, Bacillus licheniformis, Bacillus megaterium, Bacillus amyloliquefaciens, Bacillus stearothermophilus, Pseudomonas aeruginosa, Pseudomonas fluorescens, Aspergillus oryzae, Aspergillus niger, or Trichoderma reesei. For mannases, those derived from Trichoderma reesei are particularly preferred.

An α-amylase derived from Bacillus spp. is preferably used for the degumming of soy oil. In particular, for the degumming of rapeseed oil, an α-amylase derived from Bacillus spp. or Aspergillus spp. is preferred, particularly Bacillus subtilis or Aspergillus oryzae.

Triglycerides, preferably crude vegetable oils, that are brought into contact with glycoside-cleaving enzymes (Step a) and then separated into gums and (degummed) triglycerides can be used as the starting material (Step b1).

As an alternative to the triglycerides, a vegetable oil gum obtained for example by means of a conventional degumming process, such as treatment with water or aqueous acid, can be brought into contact with the glycoside-cleaving enzyme (Step a) and then separated into an aqueous lecithin-containing phase and an oil phase (Step b2). In the case of separation of the vegetable oil gum according to a conventional process, the glycoside-cleaving enzyme is added to the vegetable oil gum after it is separated, as this vegetable oil gum has not yet been brought into contact with enzyme according to the invention. Using this method, therefore, both additional oil and de-oiled lecithin can be recovered from vegetable oil gum.

Common to both of these alternatives are process steps bringing the starting materials into contact with the glycoside-cleaving enzyme and the subsequent separation into an aqueous and an oily phase, or to put it briefly, the recovery of lecithin-free oil and oil-free lecithin by enzymatic separation.

The advantage of the described process is that less oil is contained in the lecithin phase, thus reducing costs in further reprocessing, particularly in subsequent de-oiling of the lecithin. At the same time, the oil yield for further processing of the vegetable oil increases, which is also beneficial.

In a further preferred embodiment, the enzymatic activity of the glycoside-cleaving enzymes is selected in the range of 0.01 to 6 units/g oil, preferably 0.1 to 3 units/g oil, particularly preferably in the range of 0.2 to 2.5 units/g oil, and most preferably in the range of 0.3 to 1 units/g oil. (Unit: international unit of enzymatic activity; 1 unit corresponds to substrate conversion of 1 μmol/min).

In this process, for example, the enzymes cart be used in freeze-dried form or after being dissolved in water or a corresponding enzyme buffer. Preferred examples include citrate buffer 0.01-0.25 M, pH 3.8-7.5, or acetate buffer 0.01-0.25 M, pH 3.8-7.5. In a preferred embodiment, the enzymes are taken up in water or an enzyme buffer and added to the crude oil. In order to achieve better solubility of the enzymes—particularly in phospholipid-containing mixtures—, it is also possible to add organic solvents. These are used e.g. in separation of the phospholipids. One should preferably use non-polar organic solvents such as hexane or acetone or mixtures thereof, preferably in an amount of 1 to 30% (w/w) (examples of possible solvents are described in EP 1531182 A2).

In a further preferred embodiment, one or more of the enzymes is used in supported form. Preferred carrier materials within the scope of present invention are inorganic carrier materials such as silica gels, precipitated silicas, silicates or aluminosilicates, and organic carrier materials such as methacrylates or ion-exchange resins. The advantage of supported enzymes is that they are easier to separate and/or show improved reusability.

It was surprisingly found that the glycoside-cleaving enzymes according to the invention effectively reduce the gum volume and emulsifiability of vegetable oil in aqueous phases. This allows the process according to the invention to be used in a particularly advantageous manner for the degumming of crude vegetable oil or also for reprocessing of the gum phase. In this case, for example, the gum phase can be obtained by means of a conventional degumming process or the process according to the invention, if it is used for the degumming of crude vegetable oil.

Amazingly, it was found in this case that the addition of the enzymes makes it possible to increase the reaction rate in degumming, decrease the gum volume, and/or improve the separability of the gum phase formed.

The “bringing into contact” can take place in the process according to the invention by any means known to the person skilled in the art to be suitable for the purpose according to the invention. A preferred method of bringing into contact is the mixing of the crude oil and the glycoside-cleaving enzyme.

After mixing of the crude oil with the enzyme, the mixture of crude oil and enzyme is preferably stirred, thus bringing the components into contact. It is particularly preferred to carry out stirring with a paddle mixer at 200 to 800 rpm, preferably 250 to 600 rpm, and most preferably 300 to 500 rpm.

During this contact, the temperature of the mixture is preferably in the range of 15 to 99° C., more preferably to 95° C., even more preferably 30 to 80° C., likewise preferably 35 to 80° C., and particularly preferably 37 to 78° C. According to an embodiment, the temperature of the mixture during this process is always selected such that the denaturing temperature of the enzymes is not exceeded, and the temperature of the mixture is preferably at least 5° C. below the denaturing temperature of the enzymes or the lowest denaturing temperature of the enzymes. In this case, in using enzymes that are isolated from thermophilic organisms, higher temperatures are preferred as a rule. If one or more thermostable enzymes are used within the scope of the present invention, the process temperature should preferably be in the range of 60 to 120° C., and more preferably in the range of 80 to 100° C. The use of thermostable enzymes has the advantage that an increased process temperature can therefore be selected, allowing the viscosity of the vegetable oil to be decreased and the process as a whole to be shortened—also due to an elevated reaction rate of the enzymes. Moreover, pre-treatment, which is advantageously carried out even at elevated temperatures, obviates the need for subsequent cooling below a lower denaturing temperature of the enzyme used. Overall, the use of thermostable enzymes thus shortens the process and reduces costs.

Depending on how the lecithin is used, it is preferable to denature the enzymes contained in the separated lecithin, for example by heating the lecithin for 0.5 to 10 min to 80 to 100° C., depending on the enzyme used. In the case of use of thermostable enzymes, one must ensure that the lecithin is not subjected to an excessive thermal load by the denaturing process, as it will otherwise become unsightly or discolored and no longer be suitable for food applications, for example.

In this case, the duration of contact is preferably in the range of 1 min to 12 h, more preferably 5 min to 30 h, and even more preferably 10 min to 3 h.

The pH of the mixture during contact is preferably in the range of 3 to 8, and particularly preferably in the range of 3.5 to 7.5.

Separation of the gums according to Step b) of the process according to the invention can take place in any manner known to the person skilled in the art as being suitable for the purpose according to the invention. However, separation is preferably carried out by centrifugation or filtration, with centrifugation being preferred. In centrifugation, phase separation of the mixture takes place, so that the treated vegetable oil, the gums, and the enzyme composition are in separate phases that can easily be separated from one another.

In a preferred embodiment of this, the phase containing the gums and the phase containing the enzyme for the process according to the invention are separated from the treated oil. In this case, it is particularly preferred to separate the enzyme simultaneously with the gums.

A further preferred embodiment of the present invention also concerns a process as described above, further comprising the step:
c) again bringing of the triglycerides according to Step b1) into contact with the enzyme component.

This bringing into contact preferably takes place under the same conditions as described above for Step a) of the process according to the invention. In a particularly preferred embodiment, the enzymes are subjected to regeneration or purification before they are again brought into contact with the enzyme.

In a particularly preferred embodiment, the crude vegetable oil is brought into contact with water and/or acid before bringing it into contact with the enzyme according to Step a) of the process according to the invention. Preferred acids in this case are calcium- and magnesium-complexing acids alone or in combination, such as citric acid and phosphoric acid.

In a further preferred embodiment of the process according to the invention, prior to Step a) of the process, a process referred to as pre-conditioning is carried out in which the crude oil is mixed in a separate process step with an amount of 200-2000 ppm of an organic acid, preferably citric acid. The temperature of the mixture is preferably adjusted to 35 to 90° C., and particularly preferably 48° C. to 80° C. After a reaction time of 5 min to 2 h, and preferably 15 min to 1 h, the mixture is adjusted to a pH of 4-5 by adding a stoichiometric amount of alkaline solution, preferably sodium hydroxide solution, preferably in an amount of 0.5 to 2 mol/L, and particularly preferably 1 mol/L. This is followed not by separation of the aqueous phase or the saline solution from the oil phase, but by carrying out Step a) of the process according to the invention.

In a preferred embodiment of the process according to the invention, prior to Step a), the crude oil is brought into contact with water at a temperature of 30° C. to 90° C. for 5 to 240 min, and preferably 10 to 60 min, with a temperature of 35 to 90° C. being preferred and a temperature of 40 to 90° C. being particularly preferred. In a further possible embodiment, the temperature is increased before addition of the enzyme to a temperature that is optimal for the enzyme used. Temperatures of 35 to 80° C., and preferably 40 to 78° C. are suitable, and enzymes from thermophilic organisms, i.e. particularly temperature-stable enzymes, make use at 80 to 100° C. possible, so that no reduction in temperature is required between bringing the crude vegetable oil into contact with water and bringing it into contact with the enzyme of the process according to the invention. In a further possible embodiment, the aqueous phase is subsequently separated, e.g. by centrifugation.

Moreover, in a preferred embodiment, the crude oil is pre-degummed. Bringing the crude vegetable oil into contact with water or an aqueous acid, particularly citric acid or phosphoric acid, preferably takes place within the scope of the process according to the invention at a temperature of 30° C. to 90° C. for 5 to 240 min, and preferably 10 to 120 min, with a temperature of 35 to 90° C. being preferred and a temperature of 40 to 90° C. being particularly preferred. In a further possible embodiment, the acid-containing or aqueous phase is subsequently separated, for example by centrifugation. In a preferred embodiment, after acid treatment, a neutralization step with a corresponding base is carried out in order to reach a pH of 3.5 to 8.0, and 4 to 7. After this, the oil can be separated from the gums obtained, for example by centrifugation or filtration.

Before addition of the enzymes, the reaction temperature is preferably adjusted so that it does not exceed the optimal temperature range of the enzyme in order to prevent denaturing of the enzyme. Temperatures of 35 to 80° C., and preferably 40 to 78° C., are suitable, and enzymes from thermophilic organisms, i.e. particularly temperature-stable enzymes, make use at 80 to 100° C. possible, so that no reduction in temperature is required between bringing the crude vegetable oil into contact with water and/or acid and bringing it into contact with the glycoside-cleaving enzyme. An increase in temperature stability can also be achieved by immobilizing the enzymes of the enzyme components. As many enzymes exhibit a certain tolerance for organic solvents (Faber, K., Biotransformations in Organic Chemistry (2001), Springer-Verlag, Heidelberg), correspondingly pretreated oils or gums can be treated with the enzymes within the scope of the present invention.

In particularly preferred embodiments, which by no means limit the scope of the present invention, the process for the enzymatic degumming of triglycerides of the present invention comprises the following steps:

### General Embodiment 1)

a) bringing the triglycerides, preferably selected from crude soy oil and/or crude rapeseed oil and/or crude palm oil, into contact with a composition comprising at least one glycoside-cleaving enzyme, preferably an enzyme that cleaves α-glycosidic bonds, and particularly an enzyme that cleaves α(1-4)-glycosidic bonds, with the at least one glycoside-cleaving enzyme exhibiting no phospholipase and no acyltransferase activity and the composition containing no phospholipase and no acyltransferase;
b) separation of the gums from the triglycerides by centrifugation.

In this case, it is particularly preferable that the composition not contain phospholipid-cleaving enzyme, with it being most preferable that the composition also contain no enzyme having phosphatase activity.

### General Embodiment 2)

According to general embodiment 2—instead of the crude vegetable oil—the gum phase separated by a conventional degumming-process or by the process according to the invention is “brought into contact” with the glycoside-cleaving enzyme. The process preferably takes place according to embodiment 1). This process makes possible, for example, the recovery from the gum phase of oil that was contained in the gum phase and separated therefrom; this thus increases oil yield.

When recovery of the vegetable oil gum takes place according to a conventional process, e.g. with water or with an aqueous acid solution, the enzyme according to the invention can be added to the vegetable oil after separation of the (lecithin-containing) gum phase in order to extract further oil from the vegetable oil gum. In this case, the wording “after separation of the (lecithin-containing) gum phase” does not pertain to Step b2) of the process according to the invention.

In contrast to general embodiment 2), in general embodiment 1), the enzyme according to the invention is added before separation of the gum phase from oil (Step b1). This situation is determined by the sequence of Steps a) and b1).

The process steps in embodiments 1) and 2) are identical: i.e., a) bringing the starting material, whether it is (crude) triglycerides or (incompletely de-oiled) vegetable oil gum, into contact with the enzyme according to the invention, and separating the mixture into an aqueous gum phase and a triglyceride-containing oil phase in the case of triglycerides according to Step b1) or separation into an aqueous (lecithin-containing) phase and an oil phase in the case of vegetable oil gum from the starting material according to Step b2). The process is also carried out according to both embodiments 1) and 2) with the same equipment and according to the same principles. With the process according to the invention, it is possible to reduce the gum volume of the oil without using phospholipid-cleaving enzymes.

### Methods

### Determination of Oil Yield, Oil Content in the Gum Phase, and Gum Volume

The determination of oil yield, oil content in the gum phase, and gum volume can be carried out by detection of gum volume according to standardized processes such as those described in PCT/EP 2013/053 199. Moreover, the oil content of the gum can be determined separately according to DIN ISO 659 after Soxhlet extraction of the isolated gum.

### Determination of Phospholipase Activity

In order to rule out phospholipase or acyltransferase activity in the process according to the invention, the content of free fatty acids in oil during the degumming process is investigated. This is carried out according to a modification of Reference Method N.G.D. C10, of the American Oil Chemistry Society (AOCS) Ca 5a-40.

For determination of free fatty acids, one uses a FoodLab unit from the firm cdR (Italy), which constitutes an independent, compact analysis unit with a built-in spectrophotometer; it consists of a temperature-controlled incubation block with 12 cells for cuvettes and 3 independent measuring cells, each having 2 light beams of different wavelengths.

After switching on the FoodLab unit for photometric determination of the amount of free fatty acids (FFA), ready-to-use measuring cuvettes from the firm CDR are pre-heated to 37° C., after which the method of FFA determination is selected on the menu and the blank value of the cuvette is determined. After this, the required volume of vegetable oil is pipetted into the solution in the measuring cuvette, composed of a mixture of various alcohols, KOH, and phenolphthalein derivatives. Depending on FFA content, the amount of sample used is ordinarily 2.5 pL for soy oil and 1 pL for rapeseed oil. The volume taken up from the vegetable oil sample is discarded once in order to rinse the pipet, after which new sample is taken up and pipetted into the completed measuring solution. After this, the pipet is rinsed exactly 10 times with the measuring solution so as to distort the volume of the oil sample as little as possible. The pipet is then swirled 10 times by hand. The fatty acids in the sample (at pH<7.0) react with a chromogenic fraction and form a color complex, the intensity of which is then determined at 630 nm in the measuring cell of the unit. It is expressed by the unit in percent of oleic acid and is proportional to the total acid concentration of the sample.

During enzymatic degumming over 4 h, the (relative) increase in the concentration of free fatty acids, expressed as oleic acid and with respect to the total amount of all fatty acids, is generally not more than 10%, and preferably not more than 8%. Determination is carried out according to a modification of Reference Method N.G.D. C10, AOCS Ca 5a-40.

The increase in the concentration of free fatty acids during enzymatic degumming, for example of a soy oil, is not more than e.g. 0.22% (w/w) free fatty acids to 0.24% (w/w) free fatty acids, determined as free oleic acid and with respect to the total weight of the fatty acids, at a pH<7, and determined according to a modification of Reference Method N.G.D. C10, AOCS Ca 5a-40 (see Table 1).

In comparison to the enzyme according to the invention, Table 1 shows the increase in the concentration of free fatty acids, measured by the same method, with addition of a phospholipid-cleaving enzyme such as phospholipase A1 (PLA1). In the course of the reaction, the concentration of FFA increases from 0.15% (w/w) after a reaction time of 10 min to 0.34% (w/w) after 240 min, giving a relative increase in FFA concentration of 126%.

The situation is similar in enzymatic degumming of e.g. rapeseed oil (see Table 2). The amylase according to the invention derived from Aspergillus increases the concentration of free fatty acids from 1.69% (w/w) after 10 min to 1.71% (w/w) after 240 min, an increase of only 1.2% on a relative basis. The amylase PET also increases the concentration of free fatty acids from 1.76% (w/w) after 10 min to 1.79% (w/w) after 180 min, giving a relative increase in FFA concentration of 1.7%.

In contrast, the phospholipid-cleaving enzyme PLA1 increases the concentration of free fatty acids from e.g. 1.76% (w/w) after 10 min to 2.22% (w/w) after 240 min, giving a relative increase in FFA concentration of 26%.

TABLE 1
Soy oil: Results of FFA measurements in %
(w/w) during enzymatic oil degumming and comparison
with a glycoside-cleaving enzyme-phospholipase A1
(PLA1)

| Agent | 10 min | 180 min | 240 min |
|---|---|---|---|
| FFA [%] H3Cit | 0.26 | 0.25 | 0.23 |
| (citric acid) | | | |
| FFA [%] α- | 0.22 | 0.24 | 0.22 |
| amylase | | | |
| Bacillus spp. | | | |
| FFA [%] PLA1 | 0.15 | 0.31 | 0.34 |

TABLE 2
rapeseed oil: Results of the FFA measurements
in % (w/w) during enzymatic oil degumming and
comparison with a glycoside-cleaving enzyme-
phospholipase A1 (PLA1)

| Agent | 10 min | 180 min | 240 min |
|---|---|---|---|
| FFA [%] H3Cit | 1.73 | 1.68 | 1.72 |
| (citric acid) | | | |
| FFA [%] α- | 1.69 | 1.65 | 1.71 |
| amylase | | | |
| Aspergillus | | | |
| FFA [%] α- | 1.76 | 1.79 | 1.73 |
| amylase PET | | | |
| FFA [%] PLA1 | 1.76 | 1.99 | 2.22 |

TABLE 3
Soy oil: Results of FFA measurements in % (w/w) during
enzymatic oil degumming and comparison with a
glycoside-cleaving enzyme-phospholipase A1 (PLA1)

| Agent | 10 min | 60 min |
|---|---|---|
| FFA [%] (citric acid) | 0.2 | 0.2 |
| FFA [%] | 0.2 | 0.2 |
| Muramylodextranase M 719 L | | |
| FFA [%] amylase AD 11P | 0.16 | 0.15 |
| PLA1 | 0.18 | 0.29 |

The values in Tables 1 and 2 are shown in units of % (w/w) and indicate the amount of free fatty acids, calculated as oleic acid, with respect to total fatty acids. The values are determined according to a modification of Reference Method N.G.D. C10, AOCS Ca 5a-40.

### Determination of the Calcium, Magnesium and Phosphorus Content of the Vegetable Oils

Determination of phosphorus was conducted by ICP according to DEV E-22.

### Variant 1:

The amount of crude oil to be treated, 400 to 600 g, is poured into a 1000 mL DN 120 Duran reactor, and samples are removed for analysis. The oil in the Duran reactor is heated using a heating plate to a temperature of 35 to 90° C., preferably 48° C., or particularly preferably 80° C. After the temperature is reached, pre-conditioning is begun. For this purpose, a defined amount of dilute citric acid, depending on the amount of oil (e.g. 450 ppm, 1.372 mL), is metered into the oil. After this, the mixture is thoroughly mixed with an Ultraturrax for 1 min. As an alternative, the mixture can be incubated for 1 h while stirring at about 600 rpm in order to wait for the reaction of the acid. After this, a defined amount of sodium hydroxide solution (4 mol/L, residual volume to 3% (v/v), less water from acid addition and enzyme addition, is added, and incubation is continued for another 10 min while stirring. In pre-treatment at 80° C., the mixture is cooled e.g. to 50° C. before addition of the enzyme. The enzyme, the enzyme mixture, or the immobilizate is then added, preferably dissolved in buffer. The enzyme is mixed in, for which purpose the stirrer speed can be briefly increased (e.g. for 1 min to 900 rpm), after which stirring is continued at a lower speed. At the end of the reaction, the oil phase is separated from the gum phase by centrifugation, and the residual oil component of the gum phase is determined after Soxhlet extraction.

### Variant 2:

In a further implementation, glycoside-cleaving enzymes alone or in a suitable combination as free enzymes or immobilized enzymes are added to the crude oil together with a 0.05 to 5%(w/v) aqueous phase. The emulsion, composed of water, enzymes, and if applicable enzyme carriers and oil, is thoroughly mixed. Ideally, the reaction temperature is controlled to 30 to 80° C., and preferably 40 to 78° C. After this, one waits for the phase separation, the solids are precipitated, or they can be removed by a standard process known to the person skilled in the art, such as centrifugation or filtration. As a post-treatment, the residual gum can be removed from the oil with dilute acid (e.g. citric acid) or an alkaline solution using a process known to the person skilled in the art as “degumming.”

### Variant 3:

In a further implementation, oil gum is treated with enzymes. Glycoside-cleaving enzymes are added to the oil gum, which is obtained by a process known to the person skilled in the art as “degumming.” These can be dissolved in an aqueous phase or suspended in an organic solvent. The batch is ideally temperature-controlled to 20 to 70° C., and preferably 35 to 60° C. The batch is thoroughly stirred until the process is completed. This can be verified by viscosity measurements or visually, by dissolution of the otherwise solid gum phase. Centrifugation allows phase separation to be achieved, and the individual phases can be separated. As a rule, the top phase consists of the oil obtained, the middle phase consists of phospholipids, and the bottom phase is an aqueous phase containing the enzymes. By reusing the aqueous phase, it is possible to recycle and reuse the enzymes. Depending on the content of divalent ions, the oil or the enzyme-containing water phase may have to be purified by adding complexing agents before further using the ions.

### Variant 4:

In a further implementation, the crude oil is heated to a high temperature, in particular 70 to 100° C., and more specifically 75 to 85° C. The crude oil is conditioned with acid and an alkaline solution according to the above-described process, the temperature is maintained, and thermostable enzymes are added. The further procedure is as described above. The enzyme is stirred in, for which purpose the stirrer speed can be briefly increased (e.g. for 1 min to 900 rpm), after which stirring is continued at 600 rpm until the reaction is completed. The separation of the oil gum can take place as described above.

### Variant 5:

In a further implementation, the crude oil is heated to a high temperature, in particular 70 to 100° C., and more specifically 75 to 85° C. Thermostable glycoside-cleaving enzymes are added to the crude oil, alone or in a suitable combination, as free enzymes or immobilized enzymes, together with a 0.05 to 5%(w/v) aqueous phase. The emulsion, composed of water, enzyme, optionally enzyme carriers, and oil, is thoroughly stirred. The further procedure is as described above. The enzyme is mixed in, for which purpose the stirrer speed can be briefly increased (e.g. for 1 min to 900 rpm), and stirring is then continued at 600 rpm until the reaction is completed. Separation of the oil gum can take place as described above.

### EXAMPLES

The invention is explained below in greater detail by means of examples. It is emphasized here that the examples are merely illustrative in nature and demonstrate particularly preferred embodiments of the present invention. The examples by no means limit the scope of the present invention.

### Example 1

### Crude Soy Oil (with Pre-Conditioning)

According to reaction variant 1, a soy oil was subjected to pre-conditioning using aqueous citric acid (1000 ppm) and aqueous sodium hydroxide solution (4 mol/L)(total water content of the reaction: 3%). As a comparison, this same pre-conditioning was carried out with addition of an enzyme, α-amylase from the organism Bacillus spp. (Sigma-Aldrich) (see Table 1).

TABLE 3
Soy oil: total oil yield of the reactions in
Example 1 after Soxhlet extraction of the gum phase

| Agent | Oil yield [%] |
|---|---|
| H3Cit (citric acid) | 97.1 |
| α-amylase Bac. spp. | 97.9 |

### Example 2

### Crude Rapeseed Oil (with Pre-Conditioning)

According to Reaction Variant 1, rapeseed oil was subjected to pre-conditioning using aqueous citric acid (1000 ppm) and aqueous sodium hydroxide solution (4 mol/L) (total water content in the reaction: 3%). As a comparison, this same pre-conditioning was carried out with addition of an enzyme, amylase PET from the organism Bacillus subtilis (ASA Spezialenzyme GmbH), or α-amylase from Aspergillus oryzae (Sigma-Aldrich) (see Table 2).

TABLE 4
Rapeseed oil: total oil yield of the reactions
in Example 2 after Soxhlet extraction of the gum phase

| Agent | Oil yield [%] |
|---|---|
| H3Cit (citric acid) | 96.2 |
| Amylase PET | 97.4 |
| α-amylase Aspergillus | 96.4 |

Tables 1 and 2 show the total oil yield of the reactions of Examples 1 and 2 after Soxhlet extraction of the gum phase. It can be seers that the glycoside-cleaving enzymes used substantially increased the oil yield compared to the standard process with citric acid.

43 mil. tons of soy oil are produced worldwide. The volume increase in oil yield from 97.1% in the standard process to 97.9% using α-amylase from Bacillus spp. would mean that 0.35 mil. tons more of soy oil could be produced.

Approx. 23.5 mil. tons are produced from rapeseed oil worldwide. In this case, the volume increase in oil yield from 96.2% in the standard process to 97.4% using amylase PET would mean that approx. 0.3 mil. tons more of rapeseed oil could be produced.

### Example 3

### Crude Soy Oil (with Water Degumming/Lecithin Recovery)

A crude soy oil was mixed with a total amount of 21 water according to reaction variant 2. 1 unit/g oil each of the following enzymes was dissolved in the water in individual experiments: α-amylase derived from Bacillus spp. (Sigma-Aldrich), muramylodextranase M 719L, and amylase AD11P (all from the firm Biocatalysts Ltd). The suspension was incubated while stirring for 1 h at 60° C. After this, the phases were separated by centrifugation, and the oil content of the lecithin phase was determined.

TABLE 5
Oil content of lecithin phase after the
reaction from Example 3 measured after Soxhlet
extraction

| | Oil content of lecithin |
|---|---|
| Agent | phase |
| Water | 49 |
| Alpha amylase from Bacillus | 36 |
| spp. | |
| Muramylodextranase M 719 L | 33 |
| Amylase AD 11P | 34 |

Table 5 shows the oil content of the lecithin phase after reaction of the soy oils with various glycoside-cleaving enzymes compared to the standard process (water). In all cases, the amount of oil in the lecithin was decreased, which means that improved de-oiling of the lecithin took place and that the oil yield was thus simultaneously increased.

Table 6 shows that the reduced oil content in the lecithin fraction was not the result of reduced yield. Table 6 shows the ion values of the oil after the reaction. The concentrations of calcium, magnesium and phosphorus are comparable in all reactions. A similar yield of lecithin was therefore obtained.

TABLE 6
Soy oil: concentration of calcium, magnesium,
and phosphorus after reaction from Example 3

| | | Alpha | | |
|---|---|---|---|---|
| | | amylase | | |
| | | from | Muramylo- | |
| | | Bacillus | dextranase | Amylase |
| Ions | Water | spp. | M719 L | AD 11P |
| Calcium | 100 | 112 | 107 | 110 |
| [ppm] | | | | |
| Magnesium | 46 | 47 | 45 | 45 |
| [ppm] | | | | |
| Phosphorus | 180 | 215 | 194 | 185 |
| [ppm] | | | | |

TABLE 7
Enzymes used

| Name of enzyme | Enzyme | Organism | Manufacturer |
|---|---|---|---|
| Alpha amylase | Alpha | Bacillus spp. | Sigma- |
| | amylase | | Aldrich |
| Alpha amylase | Alpha | Aspergillus | Sigma- |
| | amylase | oryzae | Aldrich |
| Amylase PET | Alpha | Bacillus | ASA Spezial |
| | amylase | subtilis | Enzyme |
| Muramylodextrinase | Alpha | Aspergillus | Biocatalysts |
| 719 L | amylase, | oryzae & | Ltd. |
| | pullulanase | Bacillus | |
| | | licheniformis | |
| Amylase AD11P | Amylase | Aspergillus | Biocatalysts |
| | | oryzae | Ltd. |

What is claimed is:

1. A process, said process comprising:
a) contacting a starting material with a composition, said composition comprising at least one glycoside-cleaving enzyme, wherein the at least one glycoside-cleaving enzyme exhibits no phospholipase and no acyltransferase activity, and the composition does not contain any phospholipase or acyltransferase; and
b1) wherein said starting material is/are triglycerides, separating the gums from the triglycerides; or
b2) wherein said starting material is/are vegetable oil gum, separating into an aqueous, lecithin-containing phase and an oil-containing phase.

2. The process according to claim 1, wherein the composition does not contain phospholipid-cleaving enzymes.

3. The process according to claim 1, wherein the composition does not contain enzymes having phosphatase activity.

4. The process according to claim 1, wherein the at least one glycoside-cleaving enzyme cleaves at least one of
α(1-4)glycosidic, α(1-2)glycosidic,
α(1-6)glycosidic, β(1-2)glycosidic,
β(1-3)glycosidic, β(1-4)glycosidic or
β(1-6)glycosidic bonds.

5. The process according to claim 1, wherein the at least one glycoside-cleaving enzyme is selected from the group consisting of amylases, amyloglucosidases, isoamylases, glucoamylases, glucosidases, galactosidases, glucanases, pullulanases, arabinases, laminaranases, pectolyases, mannanases, dextranases, pectinases, cellulases, cellobiases, and xylanases.

6. The process according to claim 5, wherein the amylase is an α-amylase.

7. The process according to claim 6, wherein the α-amylase is derived from Bacillus spp., Bacillus subtilis, Bacillus licheniformis, Bacillus megaterium, Bacillus amyloliquefaciens, Bacillus stearothermophilus, Pseudomonas aeruginosa, Pseudomonas fluorescens, Aspergillus oryzae, or Aspergillus niger.

8. The process according claim 1, wherein one or more of the glycoside-cleaving enzymes is present in supported form.

9. The process according to claim 1, wherein an aqueous vegetable oil gum that accumulates in the oil degumming of one of the oils according to claim 8 is used instead of the vegetable oil.
